(19) United States
(12) Patent Application Publication
(10) Pub. No.: US 2022/0012005 A1
(43) Pub. Date: Jan. 13, 2022

(54) APPARATUS, COMPUTER-READABLE MEDIUM, AND METHOD FOR HIGH-THROUGHPUT SCREEN SHARING

(71) Applicant: Intel Corporation, Santa Clara, CA (US)

(72) Inventors: Jai Jei Soong, Penang (MY); Chia Kian Puan, Pulau Pinang (MY); Chee Meng Chiew, Penang (MY); Gary Hean Hwa Koay, Pulau Pinang (MY)

(21) Appl. No.: 17/484,138

(22) Filed: Sep. 24, 2021

(51) Int. Cl. G06F 3/14; H04L 29/06

(52) U.S. Cl. CPC G06F 3/1462; H04L 65/80; H04L 65/604

(57) ABSTRACT

Methods, apparatus, systems, and articles of manufacture are disclosed for high-throughput screen sharing. In some examples, host-viewer synchronizer circuitry determines whether a share mode is in an application or desktop share mode. In some examples, the host-viewer synchronizer circuitry tracks a visual display arrangement information of visual data on a host machine. The host-viewer synchronizer circuitry then displays the tracked visual display arrangement on a viewer machine through either replicating the tracked visual display arrangement information for one or more screen captures or for an amount of application data, depending on the type of share mode.

### FIELD OF THE DISCLOSURE

This disclosure relates generally to sharing a screen across two or more computer systems.

### BACKGROUND

Many modern computers utilize applications to share user screens among users who can be remote from each other. This is an effective way to share information and collaborate when people are not in the same room. Screen sharing involves continuously capturing the content of the screen of a host system being shared and sending a stream of the screen captures to one or more remote viewer systems. The remote systems display the stream to see what the sharing screen is displaying to essentially create as close to a real-time video stream as possible that is uploaded by the host system and simultaneously downloaded by each remote viewer system.

### BRIEF DESCRIPTION OF THE DRAWINGS

FIG. 1 is an example schematic illustration of example circuitry to implement high-throughput screen sharing across multiple computer systems.

FIG. 2 is a flowchart representative of example machine readable instructions that may be executed by example processor circuitry to implement a high-throughput screen sharing process.

FIG. 3 is a flowchart representative of example machine readable instructions that may be executed by example processor circuitry to implement a replication process of a visual display high-throughput screen sharing process using screen capture sharing technique.

FIG. 4 is a flowchart representative of example machine readable instructions that may be executed by example processor circuitry to implement another replication process of a visual display high-throughput screen sharing process using screen capture sharing technique.

FIG. 5 is a flowchart representative of example machine readable instructions that may be executed by example processor circuitry to implement a replication process of a visual display high-throughput screen sharing process using an application data sharing technique.

FIG. 6 is a flowchart representative of example machine readable instructions that may be executed by example processor circuitry to implement another replication process of a visual display high-throughput screen sharing process using an application data sharing technique.

FIG. 7 is a flowchart representative of example machine readable instructions that may be executed by example processor circuitry to implement a process for a qualitative attribution threshold check to determine the level of high-throughput screen sharing needed.

FIG. 8 is a block diagram of an example processing platform including processor circuitry structured to execute the example machine readable instructions of FIG. 2 to implement high-throughput screen sharing across multiple computer systems.

FIG. 9 is a block diagram of an example implementation of the processor circuitry of FIG. 8.

FIG. 10 is a block diagram of another example implementation of the processor circuitry of FIG. 8.

FIG. 11 is a block diagram of an example software distribution platform (e.g., one or more servers) to distribute software (e.g., software corresponding to the example machine readable instructions of FIGS. 2-7) to client devices associated with end users and/or consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Screen sharing applications are beneficial for collaboration and information sharing among remote systems. Unfortunately, a stream of screen captures (e.g., frames) at the host system sharing the screen is similar to a video stream. It is common knowledge that the majority of Internet bandwidth is used by video streams because of the significant data sizes of a stream of video frames. In many situations the bandwidth requirements are greater than what is available for a smooth stream. Thus, users commonly see frame rates drop and/or latency increase as a result. In screen sharing applications, latency and low bandwidth makes collaborating on a video/screen sharing call much more cumbersome because of dropped or delayed frames and unwanted poor resolution issues.

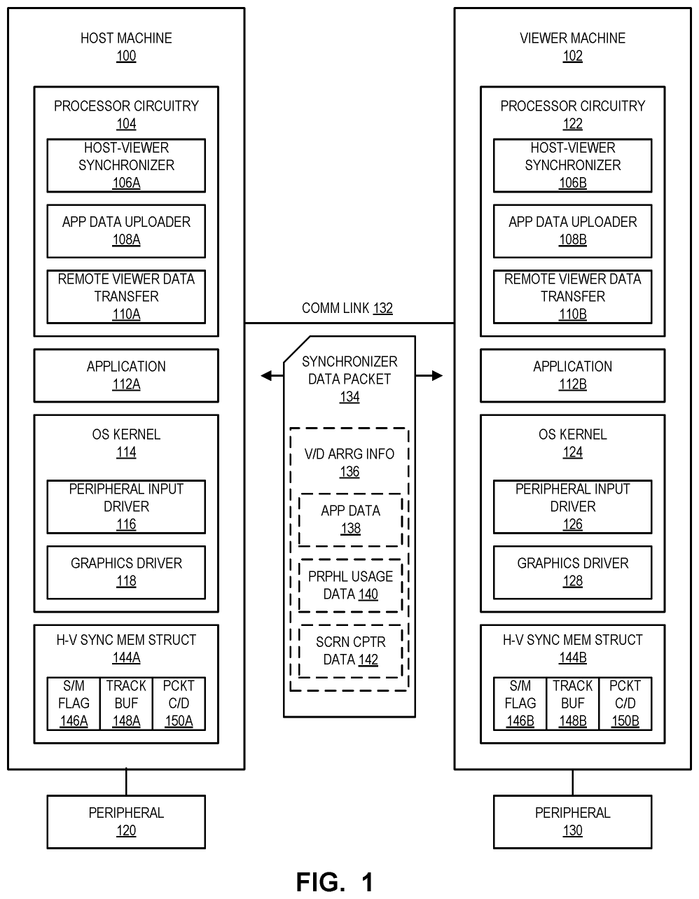

FIG. 1 is an example schematic illustration of example circuitry to implement high-throughput screen sharing across multiple computer systems. In the illustrated example, an example host machine 100 and an example viewer machine 102 are shown. In some examples, the host machine 100 shares information displayed on a host display/screen with the viewer machine 100. Although the description will focus on the host machine 100 sharing information with the viewer machine 102, in other examples, the host machine 100 and the viewer machine 102 may reverse roles (e.g., the host becomes the viewer and the viewer becomes the host) because, in a screen sharing environment among remote systems, the viewer may need to share the viewer screen to the host, which is common in a collaborative setting.

Returning to the host machine 100, in some examples it is a desktop computer, a laptop, a workstation, a server, a mobile phone, a watch, a tablet, a personal handheld device, or any one or more other types of computer systems.

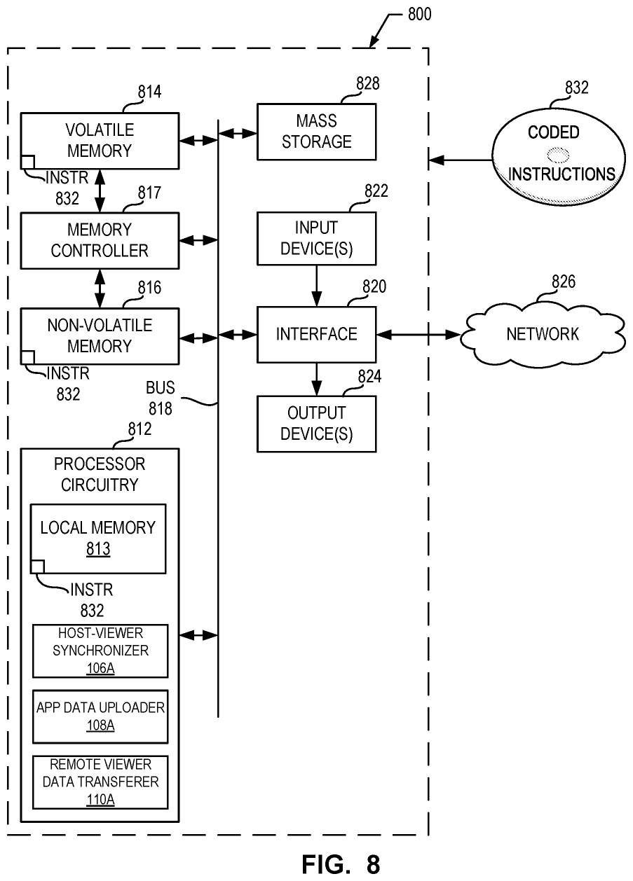

In the illustrated example in FIG. 1, the host machine 100 includes example processor circuitry 104 (described in more detail as example processor circuitry 812 in FIG. 8). In some examples, the processor circuitry 104 is a general purpose central processing unit (CPU), a fixed programmable gate array (FPGA), or another type of processor. The example processor circuitry 104 includes an example host-viewer synchronizer 106A, an example application data uploader 108A, and an example remote viewer data transferer 110A.

In some examples, the host machine 100 also includes one or more applications running on the system such as example application 112A. The example application 112A may be a word processing application, a spreadsheet application, a presentation application, a web browser, or any other type of application capable of being run on the processor circuitry 104. In some examples, the host machine 100 has an operating system (OS) being executed by the processor circuitry 100 to manage resources, applications, peripherals, etc.

In some examples, the operating system includes an example OS kernel 114 that manages low level services and other subsystems utilized by the host machine 100. In some examples, the OS kernel 114 interfaces with one or more peripheral input drivers, such as the example peripheral input driver 116. The example peripheral input driver 116 provides an interface to a peripheral communicatively coupled to the host machine 100, such as example peripheral 120.

The term “communicatively coupled” refers to the peripheral 120 and the host machine 100 being capable of passing information/data back and forth (either in a wired or wireless format). For example, if the peripheral 120 is an electronic mouse, the mouse may receive user input (e.g., movement and clicks) and provide that information to the OS kernel 114 through the peripheral input driver 116. In another example, the peripheral 120 is a display. In this example, an example graphics driver 118 provides an interface between the host machine 100 and the display. The example host machine 100 may send information from a graphics processing unit (GPU) or other circuitry capable of providing display data to the graphics driver 118 for display purposes on the display peripheral.

In some examples, there are multiple peripherals communicatively coupled to the host machine (e.g., a display, a keyboard, a mouse, a printer, a projector, and/or one or more speakers, among other peripherals).

In the illustrated example in FIG. 1, there is also the example viewer machine 102. In some examples, the viewer machine 102 is a computer system that has been tasked with viewing a shared screen (e.g., being shared by the host machine 100). In some examples, the viewer machine 100 is a desktop computer, a laptop, a workstation, a server, a mobile phone, a watch, a tablet, a personal handheld device, or any one or more other types of computer systems. In some examples, the host machine 100 and the viewer machine 102 can be two copies of a set of homogenous computer systems. In other examples, the host machine 100 and the viewer machine 102 can two completely different and unique (i.e., heterogeneous) computer systems.

In the illustrated example in FIG. 1, the viewer machine 102 includes example processor circuitry 122 (also described in more detail as example processor circuitry 812 in FIG. 8). In some examples, the processor circuitry 122 is a general purpose central processing unit (CPU), a fixed programmable gate array (FPGA), or another type of processor. The example processor circuitry 122 also includes an example host-viewer synchronizer 106B, an example application data uploader 108B, and an example remote viewer data transferer 110B. In some examples, the elements 106A and B, 108A and B, and 110A and B (in host machine 100 and viewer machine 102, respectively), are two instances of the same logic circuitry on two different systems (e.g., host machine 100 and viewer machine 102).

In some examples, the viewer machine 102 also includes one or more applications running on the system such as example application 112B. The example application 112B may be a word processing application, a spreadsheet application, a presentation application, a web browser, or any other type of application capable of being run on the processor circuitry 122. In some examples, the application 112A and the application 112B are two instances of the same application running on the two computer systems (e.g., host machine 100 and viewer machine 102).

In some examples, the viewer machine 102 also has an OS being executed by the processor circuitry 122 to manage resources, applications, peripherals, etc.

In some examples, the OS includes an example OS kernel 124 that manages low level services and other subsystems utilized by the viewer machine 102. In some examples, the OS kernel 124 interfaces with one or more peripheral input drivers, such as an example peripheral input driver 126. The example peripheral input driver 126 provides an interface to a peripheral communicatively coupled to the viewer machine 102, such as example peripheral 130.

For example, if the peripheral 130 is a keyboard, the keyboard may receive user input (e.g., typing input) and provide that information to the OS kernel 124 through the peripheral input driver 126. In another example, the peripheral 130 is a display. In this example a graphics driver 128 provides an interface between the viewer machine 102 and the display. The example viewer machine 102 may send information from a graphics processing unit (GPU) or other circuitry capable of providing display data to the graphics driver 128 for display purposes on the display peripheral.

In some examples, the host machine 100 and viewer machine 102 are communicatively coupled through an example communication link 132. The communication link may be wired or wireless and can use any known communication protocol that circuitry within each of the machines is capable of transmitting and receiving to effectively communicate. For example, the communication link 132 may utilize an ethernet protocol, one of many wireless protocols, cellular protocols, or any other known protocol that provides a standard method for sending and receiving data between two or more systems.

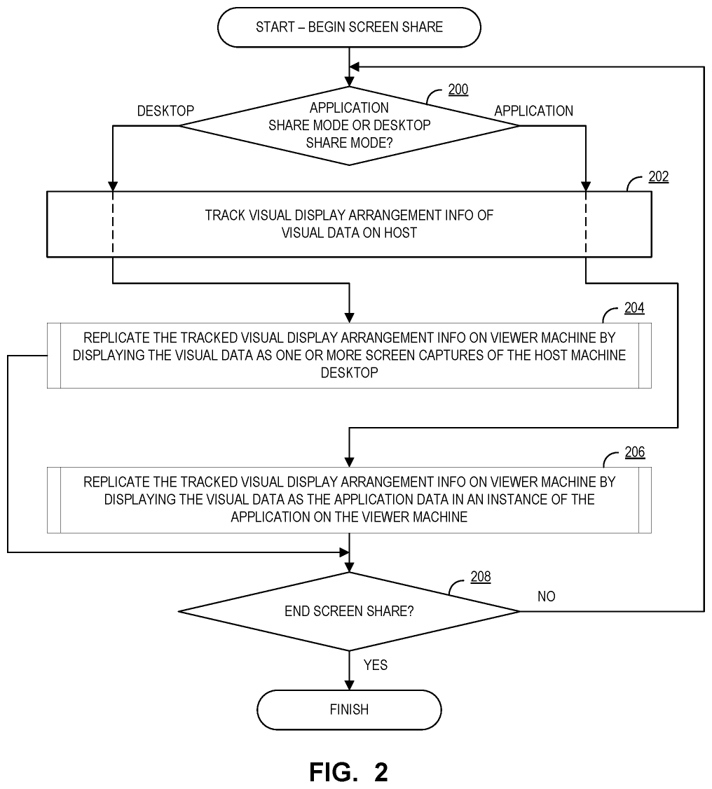

In some examples, the host machine 100 shares information displayed on its screen/display (e.g., a display peripheral coupled to the host machine 100) with the viewer machine. The remaining elements of FIG. 1 will be described in the context of the example flow charts illustrated in FIGS. 2-7, which are discussed below.

FIG. 2 is a flowchart representative of example machine readable instructions that may be executed by example processor circuitry to implement a high-throughput screen sharing process. In some examples, the process flow is performed by the host-viewer synchronizer circuitry 106A in FIG. 1 and the host-viewer synchronizer circuitry 106B in FIG. 1.

In the illustrated example of FIG. 2, the process begins when the host machine (100 in FIG. 1) begins sharing visual data on the screen with a remote viewer machine (102 in FIG. 1).

At block 200, the example host-viewer synchronizer circuitry 106A determines whether a share mode to share the visual data from the host machine 100 is in an application share mode or a desktop share mode. The application share mode is defined as a share mode where the host machine 100 visually shares the present content of an application (e.g., application 112A) running on and being displayed by the host machine 100 with the viewer machine 102. The desktop share mode is defined as a share mode where the host machine 100 visually shares screen captures of the present content of the host machine's 100 OS's desktop. In some examples, this may include the wallpaper, icons, and any open application windows on the desktop, among other items.

In some examples, the share mode is determined automatically by the focus (e.g., the active window in the OS) of what is displayed on the host machine 100 screen. For example, if the active window is an application such as a word processor, then the share mode may be set to that application. In other examples, the share mode is a manual determination for the user when sharing their screen. For example, a selection window in a user interface of the sharing application may allow the user to decide if they want an application as the focus or the desktop as the focus.

Returning to FIG. 1, the share mode determination may be implemented as reading an example share mode flag (S/M FLAG) 146A in an example host-viewer synchronizer memory structure 144A. In some examples, the host-viewer synchronizer memory structure 144A is a structure initialized in a memory in the host machine 100 when the host machine 100 begins sharing its screen/display contents. The example host-viewer synchronizer memory structure 144A may be located in a main system memory, in a local memory to the processor, in a cache in the processor circuitry 104, implemented in one or more registers associated with the processor circuitry 104, in a non-volatile storage system in the host machine, or anywhere else capable of storing a memory structure.

In FIG. 2, at block 202, regardless of which share mode is currently active, the example host-viewer synchronizer circuitry 106A then begins to track visual display arrangement information of visual data on the host machine's 100 screen/display. In some examples, the example host-viewer synchronizer circuitry 106A has access to a graphics driver 118 frame buffer of the host machine 100 screen as well as access to inputs from any peripherals through one or more peripheral input driver(s) 116. The visual display arrangement information is defined as the informational I/O aspects of how the host machine 100 screen presently looks and the reasons behind any changes. For example, the host-viewer synchronizer circuitry 106A has access to inputs that modify and manipulate the content of the host machine 100 screen/display as well as to the actual output of the host machine 100 display.

In FIG. 1, in some examples, the host-viewer synchronizer circuitry 106A initializes and maintains an example tracking buffer 148A (e.g., stored in the host-viewer synchronizer memory structure 144A) to keep track of the visual display arrangement information of the visual data on the host machine 100 screen. In some examples, the inputs and outputs discussed above are stored in the tracking buffer 148A for use by the host-viewer synchronizer circuitry 106A when sending visual data/information to the viewer machine 102.

In FIG. 2, after gathering the visual display arrangement information of the visual data (and storing it in the tracking buffer 148A), the example host-viewer synchronizer circuitry 106A transfers the visual display arrangement information to the example host-viewer synchronizer circuitry 106B on the viewer machine 102 (e.g., across the communication link 132).

In FIG. 1, in some examples, an example synchronizer data packet 134 is defined for any instance of the host-viewer synchronizer circuitry, such as 106 A and B. In some examples, the packet definition includes any necessary data to be transferred between a host and a viewer. For example, packets may include example visual display arrangement information 136, example application data 138, example peripheral usage data 140, and/or example screen capture data 142. In some examples, the specific data sent per synchronizer data packet 134 is added depending on the current need of the host-to-viewer share stream type.

In some examples, an example packet constructor/deconstructor memory space 150A in the host-viewer synchronization memory structure 144A provides the host-viewer synchronizer circuitry 106A a range of memory that can be used to construct the synchronizer data packet(s) 134 as the host. In some examples, the viewer machine 102 also has an example host-viewer synchronizer memory structure 144B with the same elements, such as an example share mode flag location 146B, an example tracking buffer 148B (e.g., when the viewer turns into the host), and an example packet constructor/deconstructor memory space 150B (e.g., to deconstruct the arriving packet(s) 134 as the viewer).

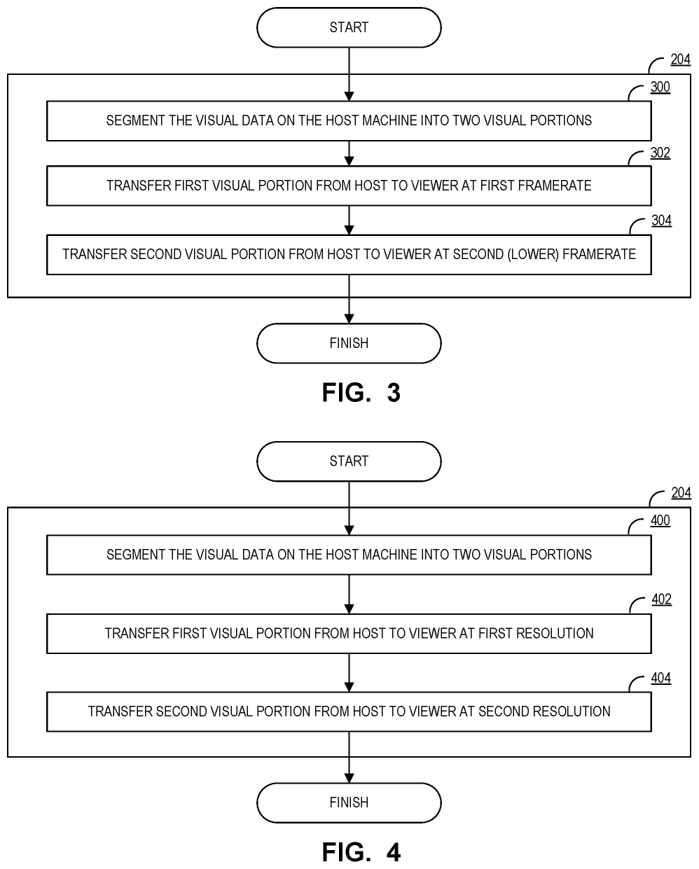

In FIG. 2, once the visual display arrangement information has been tracked and transferred to the viewer machine 102, then, if the share mode was determined to be in desktop share mode, at block 204, the host-viewer synchronizer circuitry 106B replicates the tracked visual display arrangement on the viewer machine 100 by displaying an amount of visual data of one or more screen captures of the host machine's 100 OS desktop. In some examples, the screen captures are constructed from the screen capture data 142 in the synchronizer data packet(s) 134. More details of the processes that take place in the desktop mode are discussed below in the description of FIGS. 3-4.

In some examples, once the visual display arrangement information has been tracked and transferred to the viewer machine 102, then, if the share mode was determined to be in application share mode, at block 206, the host-viewer synchronizer circuitry 106B replicates the tracked visual display arrangement information on the viewer machine 100 by displaying the visual data as the application data in an instance of the application 112B on the viewer machine 102.

For example, if the application being shared is a word processor application, then application data in the form of a file of the word processor format is shared/sent from the host-viewer synchronization circuitry 106A in the host machine 100 to the host-viewer synchronization circuitry 106B in the view machine 102. Instead of sending a series of screen captures, the host machine initially sends the file (e.g., the application data) and the viewer machine 102 then has a local copy of the file and loads it in a local copy of the application 112B. In some examples, very little data is required to be transferred from the host machine 100 to the viewer machine 102 after the host machine 100 sends the initial file. In some examples, the application data (e.g., the file(s)) is sent in one or more synchronizer data packets 134 in an app data section/format 138.

In the illustrated flowchart in FIG. 2, after both blocks 204 and 206, the process continues at block 208 where the example host-viewer synchronizer circuitry 106A determines if the screen share has ended. If so, the process in FIG. 2 is finished. Otherwise, the process returns to block 200 to continue screen sharing.

In some examples, the screen share process is initiated by the host machine 100 and a start-screen-share synchronizer data packet 134 is sent from the host-viewer synchronizer circuitry 106A in the host machine 100 to the host-viewer synchronizer circuitry 106B in the viewer machine 102 to indicate the start. In some examples, when the host-viewer synchronizer circuitry 106B receives the start-screen-share packet, it initializes the host-viewer synchronizer memory structure 144B to be ready to receive visual data in the form of synchronizer data packets 134 across the communication link 132. In some examples, the host-viewer synchronizer circuitry 106A in the host machine 100 sends a stop-screen-share synchronizer data packet 134 to the host-viewer synchronizer circuitry 106B in the viewer machine 102 to indicate the screen share is over. Once the screen share is over, both the host-viewer synchronizer circuitry 106A in the host machine 100 and the host-viewer synchronizer circuitry 106B in the viewer machine 102 can initiate any memory clean up procedures (as well as any other clean up procedures) related to their operation. At this point, the process illustrated in FIG. 2 is complete.

FIG. 3 is a flowchart representative of example machine readable instructions that may be executed by example processor circuitry to implement a replication process of a visual display high-throughput screen sharing process using screen capture sharing technique. In some examples, the process flow is performed by the host-viewer synchronizer circuitry 106A in FIG. 1 and the host-viewer synchronizer circuitry 106B in FIG. 1. In some examples, the process described in FIG. 3 is included as at least a portion of the process within block 204 in FIG. 2.

In the illustrated example of FIG. 3, the process begins, at block 300, when the example host-viewer synchronizer circuitry 106A in the host machine 100 segments the visual data on the host machine into two visual portions. In some examples, the two visual portions are separated by the host-viewer synchronizer circuitry 106A determining, between two screen captures at two differing timestamps, whether the screen has changed (e.g. been modified) by a threshold modification level of pixels.

In some examples, the visual portions are allowed to be designated by an X,Y coordinate system of pixels on the host machine 100. Thus, in some examples, the two visual portions are limited to being separated by either a horizontal line or a vertical line. In other examples, additional portions may be designated in an X,Y coordinate system to break up the visual data into additional portions. In the two portion example, a first portion of the screen may be normally without movement. For example, in a word processor, the top rectangular bar of the screen may include a quick access menu of drop down menus and buttons. When a document is being manipulated, there is generally less movement in the menu area of the word processor while there is more movement in the document display area. Thus, in some examples, the host-viewer synchronizer circuitry 106A segments the two visual portions based on a threshold modification level of the visual data on the screen.

At block 302, the example host-viewer synchronizer circuitry 106A transfers the first visual portion from the host machine 100 to the viewer machine 102 at a first frame rate. In some examples, the first visual portion may exceed a threshold modification level of the visual data between a plurality of screen captures. In some examples, if the threshold is exceeded, the frame rate may be a standard screen sharing frame rate of the visually changing portion of the screen to minimize choppiness.

At block 304, the example host-viewer synchronizer circuitry 106A transfers the second visual portion from the host machine 100 to the viewer machine 102 at a second frame rate. In some examples, the second framerate is lower, which may not affect viewing the visual data in the second portion if there is no or little movement.

In some examples, the example host-viewer synchronizer circuitry 106B on the viewer machine 102 takes the two visual portions and reconstructs frames to display. In some examples, the reconstruction of the frames takes place in the packet construction memory range 150B in the host-viewer synchronizer memory structure 144B. For example, if the first visual portion of the data is sent in packets at 30 frames per second and the second visual portion of the data is sent in packets at 1 frame per second, the host-viewer synchronizer circuitry 106B on the viewer machine 102 uses the same second visual portion of the data for 30 consecutive frames while using 30 unique first visual portions of the data. This methodology lowers screen sharing bandwidth requirements because entire frames of the screen are not being sent at the higher framerate.

In other examples, the two visual portions are based on a first portion (a smaller X,Y box) of higher movement data surrounding a mouse cursor that is moving around the screen and a second visual portion of the entire screen (in X,Y). Here, the example host-viewer synchronizer circuitry 106A sends the first visual portion of data covering the moving smaller X,Y box at the higher framerate and overlays it over the portion of the larger second visual portion at the accurate location for the small box.

At this point, the process illustrated in FIG. 3 is complete.

FIG. 4 is a flowchart representative of example machine readable instructions that may be executed by example processor circuitry to implement another replication process of a visual display high-throughput screen sharing process using screen capture sharing technique. In some examples, the process flow is performed by the host-viewer synchronizer circuitry 106A in FIG. 1 and the host-viewer synchronizer circuitry 106B in FIG. 1. In some examples, the process described in FIG. 4 is included as at least a portion of the process within block 204 in FIG. 2.

In the illustrated example of FIG. 4, the process begins, at block 400, when the example host-viewer synchronizer circuitry 106A in the host machine 100 segments the visual data on the host machine into two visual portions. In some examples, the reasoning behind the separation of the two visual portions is the same between the FIG. 3 process and the FIG. 4 process. Again, in some examples, the two visual portions are separated by the host-viewer synchronizer circuitry 106A determining, between two screen captures at two differing timestamps, whether the screen has changed (e.g., has been modified) by a threshold modification level of pixels.

At block 402, the example host-viewer synchronizer circuitry 106A transfers the first visual portion from the host machine 100 to the viewer machine 102 at a first resolution (e.g., a first image resolution of pixels per inch). In some examples, the first visual portion pixel resolution may a higher resolution to show a sharp screen capture in an area of focus.

At block 404, the example host-viewer synchronizer circuitry 106A transfers the second visual portion from the host machine 100 to the viewer machine 102 at a second resolution. In some examples, the second resolution is lower number of pixels per inch, which may be acceptable to a viewer if the second visual portion is in an area of lesser focus.

For example, take the word processor example again, the quick access drop down menus and buttons may not be needed in high resolution for viewing because the active content in a screen sharing collaboration is only in the word processing document viewing window. In this example, the entire screen capture image is sent in every frame, but a portion of the frame is less dense in pixel resolution, thus allowing for a reduced transfer bandwidth of visual data across the communication link 132, which may not affect viewing the visual data in the second portion if there is no or little movement.

In some examples, the example host-viewer synchronizer circuitry 106B in the viewer machine 102 may need to reconstruct the two visual portions of each frame when received if they are separated. At this point, the process illustrated in FIG. 4 is complete.

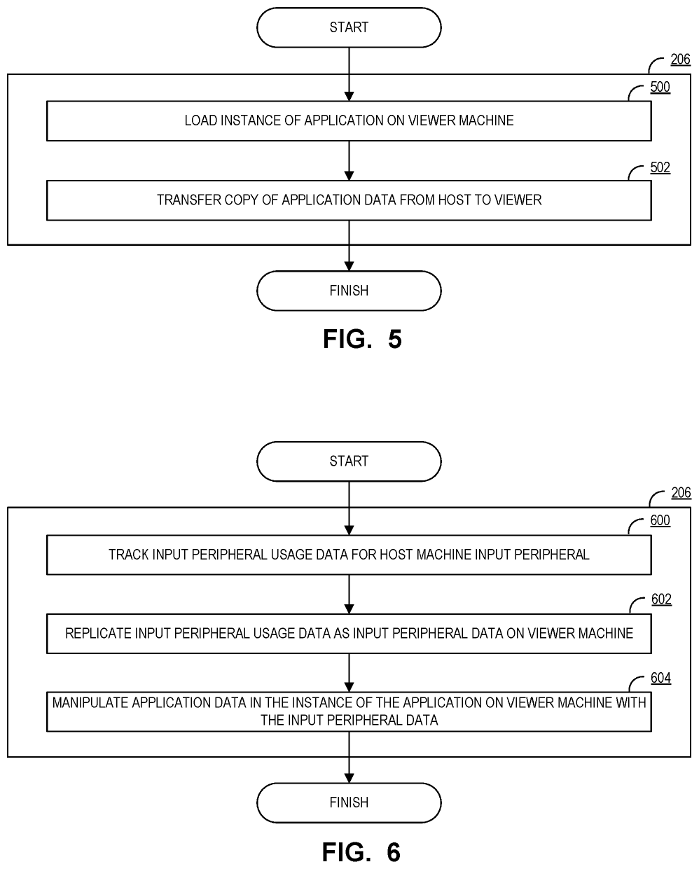

FIG. 5 is a flowchart representative of example machine readable instructions that may be executed by example processor circuitry to implement a replication process of a visual display high-throughput screen sharing process using an application data sharing technique. In some examples, the process flow is performed by the application data uploader circuitry 108A in the host machine 100 in FIG. 1 and the application data uploader circuitry 108B in the viewer machine 200 in FIG. 1. In some examples, the process described in FIG. 5 is included as at least a portion of the process within block 206 in FIG. 2.

In the illustrated example of FIG. 5, the process begins, at block 500, when the example application data uploader circuitry 108B loads an instance of the application being shared on the viewer machine 102. In some examples, the application data uploader circuitry 108A in host machine 100 sends a start-screen-share initialization synchronizer data packet 134 (or later sends an update-screen-share synchronizer data packet 134 packet). Within one or more of these packets an indicator of the application being shared, thus, the application data uploader circuitry 108B in the viewer machine 102 is given awareness of an application to share and loads the application 112B for use.

At block 502, the example application data uploader circuitry 108A in the host machine 100 transfers a copy of the application data from the host machine 100 to the viewer machine 102. In some examples, the copy of the application data is a copy of a document, spreadsheet, presentation, etc., that is capable of being loaded in the associated application 112B. The local copy of the application data at the viewer machine 102 provides the viewer machine 102 access to the source application data and removes a need to provide screen captures across the communication link 132. At this point, the process illustrated in FIG. 5 is complete.

FIG. 6 is a flowchart representative of example machine readable instructions that may be executed by example processor circuitry to implement another replication process of a visual display high-throughput screen sharing process using an application data sharing technique. In some examples, the process flow is performed by the host-viewer synchronizer circuitry 106A in the host machine 100 in FIG. 1 and host-viewer synchronizer circuitry 106B in the viewer machine 200 in FIG. 1. In some examples, the process described in FIG. 6 is included as at least a portion of the process within block 206 in FIG. 2.

In the illustrated example of FIG. 6, the process begins, at block 600, when the example host-viewer synchronizer circuitry 106A tracks input peripheral usage data for a host machine 100 input peripheral (e.g., peripheral 120). For example, with an electronic mouse, the mouse is manipulated by a user (at host machine 100) and provides a series of movement and click data to the associated (mouse) peripheral input driver 116. This stream of mouse input usage data is tracked by the host-viewer synchronizer circuitry 106A and stored in a tracking buffer 148A in the host-viewer synchronizer memory structure 144A.

In some examples, the host-viewer synchronizer circuitry 106A then constructs one or more synchronizer data packets 134 in the packet constructor memory space 150A in the host-viewer synchronizer memory structure 144A. In some examples, the host-viewer synchronizer circuitry 106A utilizes an example peripheral usage data format 140 stored as part of the visual display arrangement information 136 in the packet and the packet is then transferred across the communication link 132 to the viewer machine 102. In some examples, the host-viewer synchronizer circuitry 106B in the viewer machine 102 deconstructs the packet and retrieves the peripheral usage data.

At block 602, the example host-viewer synchronizer circuitry 106B replicates the input peripheral usage data as local input peripheral data on the viewer machine 102. In some examples, the input peripheral usage data from the one or more packets is saved in the local tracking buffer 148B in the host-viewer synchronizer memory structure 144B on the viewer machine 102.

At block 604, the example host-viewer synchronizer circuitry 106B manipulates the application data (received at the viewer machine 102 from the process completed in FIG. 5) in the instance of the application that has been loaded onto the viewer machine 102 using the input peripheral data loaded in the tracking buffer 148B.

In some examples, the input peripheral data causes the application data (e.g., a file) to be manipulated in the local instance of the application. No screen captures are transferred in this process. Rather, in the illustrated example, the application data is transferred at the beginning of the process (see FIG. 5), followed by the peripheral usage data to allow for a local manipulation of the application data mimicking how the manipulation is taking place on the host device 100. In some examples, the local copy of the application data on the viewer machine 102 is locked from modifications by a local user at the viewer machine (e.g., only the peripheral data can manipulate the application data). At this point, the process illustrated in FIG. 6 is complete.

In some examples, the application 112A being shared is an Internet webpage browser. In some examples, the transferred application data 138 for the Internet webpage browser is an Internet address (e.g., a uniform resource locator (URL)). In some examples, the application data uploader 108B loads the Internet webpage browser application 112B on the viewer machine 102 and the host-viewer synchronizer circuitry 106B inputs the Internet address into the Internet webpage browser to load the application data into the local instance of the application 112B in the viewer machine 102.

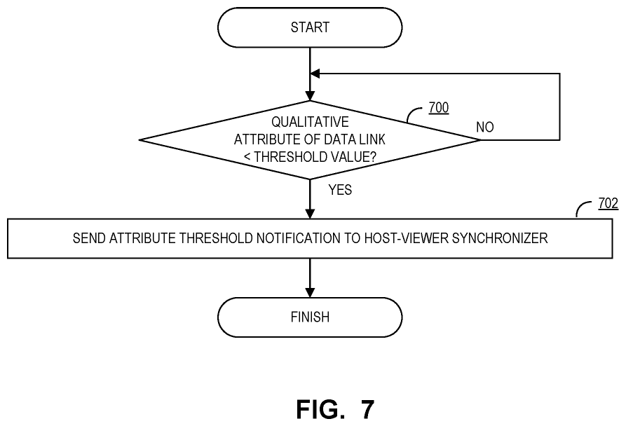

FIG. 7 is a flowchart representative of example machine readable instructions that may be executed by example processor circuitry to implement a process for a qualitative attribution threshold check to determine the level of high-throughput screen sharing needed. In some examples, the process flow is performed by the remote viewer data transfer circuitry 110A in the host machine 100 in FIG. 1 and the remote viewer data transfer circuitry 110B in the viewer machine 200 in FIG. 1.

In the illustrated example of FIG. 7, the process begins, at block 700, when the example remote viewer data transfer circuitry 110A and/or 110B makes a qualitative attribute check of the data link between the host machine 100 and the viewer machine 102. In some examples, the remote viewer data transfer circuitry 110A/B tests a latency between packets being sent and received across the communication link 132.

Additionally or alternatively, in some examples, the remote viewer data transfer circuitry 110A/B tests a bandwidth over time of a series of packets being sent and received across the communication link. In some examples, a prompt at each machine requests user input for a quality of signal and utilizes that input on a sliding scale to make a determination as to a qualitative attribute check of the communication link 132. In yet other examples, a combination of two or more of these qualitative attribute checks are combined for additional accuracy in a determination of one or more qualitative attributes of the data link (e.g., data stream) across the communication link 132.

In some examples, if the qualitative attribute exceeds the threshold modification level (or equal the attribute threshold), then no change in technique is needed to reduce the bandwidth. In some examples, the attribute threshold is a minimum quality standard to maintain a specific type of screen sharing. In some examples, if the qualitative attribute is determined to be below the attribute threshold, then at block 702, the example remote viewer data transfer circuitry 110A and/or 110B sends a notification to the local host-viewer synchronizer 106A or 106B. In some examples, the local host-viewer synchronizer 106A/B, initiates one or more of the processes described above in FIGS. 2-6 in response to the notification being received (e.g., when the notification is received). In some examples, there are multiple tiers of qualitative thresholds. In some embodiments, for each lower tier, a screen sharing technique with greater bandwidth savings is implemented. At this point, the process illustrated in FIG. 6 is complete.

In some examples, the screen sharing system shown between the host machine 100 and the viewer machine 102 is only a small part of a larger network of machine, many of which have an instantiation of the system illustrated in FIG. 1.

While an example manner of implementing the host-viewer synchronizer circuitry 106A and 106B, the application data uploader circuitry 108A and 108B, and the remote viewer data transfer circuitry 110A and 110B of FIG. 1 is illustrated in FIG. 8, one or more of the elements, processes, and/or devices illustrated in FIG. 8 may be combined, divided, re-arranged, omitted, eliminated, and/or implemented in any other way. Further, the example host-viewer synchronizer circuitry 106A and 106B, the application data uploader circuitry 108A and 108B, and the remote viewer data transfer circuitry 110A and 110B may be implemented by hardware alone or by hardware in combination with software and/or firmware. Thus, for example, any of the example the example host-viewer synchronizer circuitry 106A and 106B, the application data uploader circuitry 108A and 108B, and the remote viewer data transfer circuitry 110A and 110B could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example the example host-viewer synchronizer circuitry 106A and 106B, the application data uploader circuitry 108A and 108B, and the remote viewer data transfer circuitry 110A and 110B may include one or more elements, processes, and/or devices in addition to, or instead of, those illustrated in FIG. 8, and/or may include more than one of any or all of the illustrated elements, processes and devices.

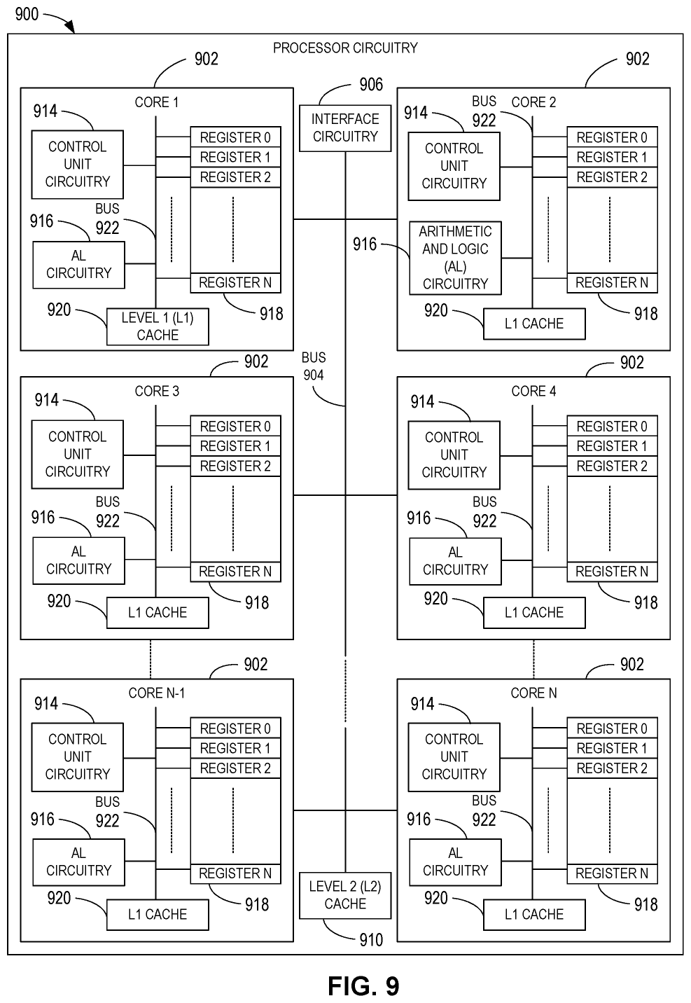

Flowcharts representative of example hardware logic circuitry, machine readable instructions, hardware implemented state machines, and/or any combination thereof for implementing the example host-viewer synchronizer circuitry 106A and 106B, the application data uploader circuitry 108A and 108B, and the remote viewer data transfer circuitry 110A and 110B are shown in FIGS. 2-7. The machine readable instructions may be one or more executable programs or portion(s) of an executable program for execution by processor circuitry, such as the processor circuitry 812 shown in the example processor platform 800 discussed below in connection with FIG. 8 and/or the example processor circuitry discussed below in connection with FIGS. 9 and/or 10. The program(s) may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program(s) is(are) described with reference to the flowcharts illustrated in FIGS. 2-7, many other methods of implementing the example host-viewer synchronizer 106A and 106B, the application data uploader circuitry 108A and 108B, and the remote viewer data transfer circuitry 110A and 110B may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2-7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a block diagram of an example processor platform 800 structured to execute and/or instantiate the machine readable instructions and/or operations of FIGS. 2-7 to implement the host machine 100 and/or the viewer machine 102 of FIG. 1. The processor platform 800 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 implements the host-viewer synchronizer 106A, the application data uploader circuitry 108A, and the remote viewer data transfer circuitry 110A when the processor platform 800 implements the host machine 100. In this example, the processor circuitry 812 implements the host-viewer synchronizer 106B, the application data uploader circuitry 108B, and the remote viewer data transfer circuitry 110B when the processor platform 800 implements the viewer machine 102.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 832, which may be implemented by the machine readable instructions of FIGS. 3-8, may be stored in the mass storage device 828, in the volatile memory 814, in the non-volatile memory 816, and/or on a removable non-transitory computer readable storage medium such as a CD or DVD.

FIG. 9 is a block diagram of an example implementation of the processor circuitry 812 of FIG. 8. In this example, the processor circuitry 812 of FIG. 8 is implemented by a microprocessor 900. For example, the microprocessor 900 may implement multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 2-7.

The cores 902 may communicate by an example bus 904. In some examples, the bus 904 may implement a communication bus to effectuate communication associated with one(s) of the cores 902. For example, the bus 904 may implement at least one of an Inter-Integrated Circuit (I2C) bus, a Serial Peripheral Interface (SPI) bus, a PCI bus, or a PCIe bus. Additionally or alternatively, the bus 904 may implement any other type of computing or electrical bus. The cores 902 may access data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2_ cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the L1 cache 920, and an example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The bus 920 may implement at least one of an I2C bus, a SPI bus, a PCI bus, or a PCIe bus

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

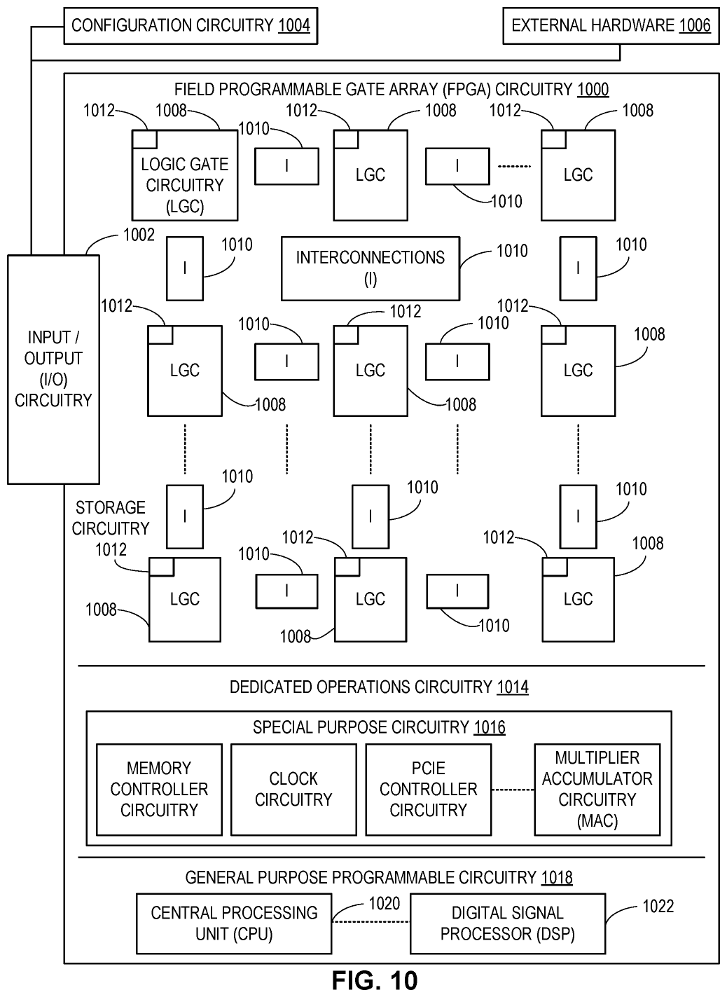

FIG. 10 is a block diagram of another example implementation of the processor circuitry 812 of FIG. 8. In this example, the processor circuitry 1012 is implemented by FPGA circuitry 1000. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the machine readable instructions in hardware and, thus, can often execute the operations faster than they could be performed by a general purpose microprocessor executing the corresponding software.

More specifically, in contrast to the microprocessor 900 of FIG. 9 described above (which is a general purpose device that may be programmed to execute some or all of the machine readable instructions represented by the flowcharts of FIGS. 2-7 but whose interconnections and logic circuitry are fixed once fabricated), the FPGA circuitry 1000 of the example of FIG. 10 includes interconnections and logic circuitry that may be configured and/or interconnected in different ways after fabrication to instantiate, for example, some or all of the machine readable instructions represented by the flowcharts of FIGS. 2-7. In particular, the FPGA 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the software represented by the flowcharts of FIGS. 2-7. As such, the FPGA circuitry 1000 may be structured to effectively instantiate some or all of the machine readable instructions of the flowcharts of FIGS. 2-7 as dedicated logic circuits to perform the operations corresponding to those software instructions in a dedicated manner analogous to an ASIC. Therefore, the FPGA circuitry 1000 may perform the operations corresponding to the some or all of the machine readable instructions of FIG. 10 faster than the general purpose microprocessor can execute the same.

In the example of FIG. 10, the FPGA circuitry 1000 is structured to be programmed (and/or reprogrammed one or more times) by an end user by a hardware description language (HDL) such as Verilog. The FPGA circuitry 1000 of FIG. 10, includes example input/output (I/O) circuitry 1002 to access and/or output data to/from example configuration circuitry 1004 and/or external hardware (e.g., external hardware circuitry) 1006. For example, the configuration circuitry 1004 may implement interface circuitry that may access machine readable instructions to configure the FPGA circuitry 1000, or portion(s) thereof. In some such examples, the configuration circuitry 1004 may access the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1006 may implement the microprocessor 900 of FIG. 9. The FPGA circuitry 1000 also includes an array of example logic gate circuitry 1008, a plurality of example configurable interconnections 1010, and example storage circuitry 1012. The logic gate circuitry 1008 and interconnections 1010 are configurable to instantiate one or more operations that may correspond to at least some of the machine readable instructions of FIGS. 2-7 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 1012 of FIG. 10, many other approaches are contemplated. For example, as mentioned above, modern FPGA circuitry may include an on-board CPU, such as one or more of the example CPU 1020 of FIG. 10. Therefore, the processor circuitry 812 of FIG. 8 may additionally be implemented by combining the example microprocessor 900 of FIG. 9 and the example FPGA circuitry 1000 of FIG. 10. In some such hybrid examples, a first portion of the machine readable instructions represented by the flowcharts of FIGS. 2-7 may be executed by one or more of the cores 902 of FIG. 9 and a second portion of the machine readable instructions represented by the flowcharts of FIGS. 2-7 may be executed by the FPGA circuitry 1000 of FIG. 10.

In some examples, the processor circuitry 812 of FIG. 8 may be in one or more packages. For example, the processor circuitry 900 of FIG. 9 and/or the FPGA circuitry 1000 of FIG. 10 may be in one or more packages. In some examples, an XPU may be implemented by the processor circuitry 1012 of FIG. 10, which may be in one or more packages. For example, the XPU may include a CPU in one package, a DSP in another package, a GPU in yet another package, and an FPGA in still yet another package.

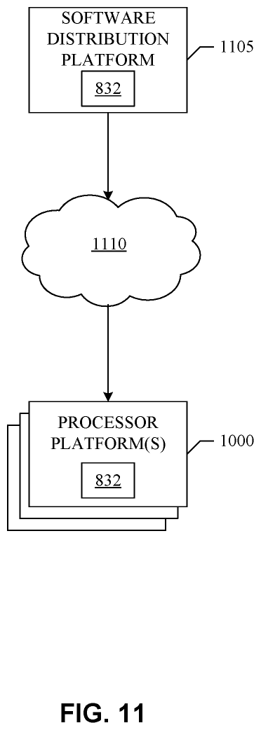

A block diagram illustrating an example software distribution platform 1105 to distribute software such as the example machine readable instructions 832 of FIG. 8 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 2-7, as described above. The one or more servers of the example software distribution platform 1105 are in communication with a network 1110, which may correspond to any one or more of the Internet and/or the example network 826 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 11, may be downloaded to the example processor platform 800, which is to execute the machine readable instructions 832 to implement the host machine 100 and/or the viewer machine 102. In some example, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices.

From the foregoing, it will be appreciated that example systems, methods, apparatus, and articles of manufacture have been disclosed to implement high-throughput screen sharing. The disclosed systems, methods, apparatus, and articles of manufacture decrease the amount of data needed across a communication link between any two computer systems that are screen sharing with each other. The disclosed systems, methods, apparatus, and articles of manufacture are accordingly directed to one or more improvement(s) in the operation of a machine such as a computer or other electronic and/or mechanical device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent. Further examples and combinations thereof include the following:

Example 1 includes an apparatus to implement screen sharing, the apparatus comprising processor circuitry including one or more of at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or an Application Specific Integrate Circuitry (ASIC) including logic gate circuitry to perform one or more third operations, the processor circuitry to perform at least one of the one or more first operations, the one or more second operations or the one or more third operations to instantiate host-viewer synchronizer circuitry to determine whether a share mode to share visual data from a host machine to a viewer machine is in an application share mode to share application data associated with an application or in a desktop share mode to share one or more screen captures of an operating system desktop, track visual display arrangement information of an amount of the visual data on the host machine, display the amount of visual data on the viewer machine as one or more screen captures of the operating system desktop from the host machine by replicating a first amount of the tracked visual display arrangement information on the viewer machine in response to the share mode being in the desktop share mode, and display the amount of visual data on the viewer machine as the application data in an instance of the application by replicating a second amount of the tracked visual display arrangement information on the viewer machine in response to the share mode being in the application share mode.

Example 2 includes the apparatus of example 1, wherein the processor circuitry is to perform at least one of the one or more first operations, the one or more second operations or the one or more third operations to instantiate application data uploader circuitry to in response to the share mode being in the application share mode, load the instance of the application on the viewer machine, and transfer a copy of the application data from the host machine to the viewer machine, the application data based on the second amount of the tracked visual display arrangement information.

Example 3 includes the apparatus of example 2, wherein the host-viewer synchronizer circuitry is to track an amount of input peripheral usage data for at least one input peripheral associated with the host machine, the amount of input peripheral usage data being at least a portion of the second amount of the tracked visual display arrangement information, and replicate at least a portion of the amount of input peripheral usage data as input peripheral data on the viewer machine.

Example 4 includes the apparatus of example 3, wherein to replicate the second amount of the tracked visual display arrangement information in the instance of the application on the viewer screen, the host-viewer synchronizer circuitry is to manipulate the application data in the instance of the application on the viewer machine based on the input peripheral data.

Example 5 includes the apparatus of any one of examples 1 to 4, wherein the host-viewer synchronizer circuitry is to in response to the application being an Internet browsing application viewing a webpage at an address, load the address in the instance of the application on the viewer machine to display the webpage, the address being at least a portion of the second amount of the tracked visual display arrangement information.

Example 6 includes the apparatus of example 1, wherein the host-viewer synchronizer circuitry is to in response to the share mode being in the desktop share mode, segment the visual data of the one or more screen captures into at least two visual portions, wherein a first visual portion of the at least two visual portions is above a threshold modification level of the visual data between the plurality of screen captures, a second visual portion of the at least two visual portions is below a threshold modification level of the visual data between the plurality of screen captures, and the at least two visual portions are at least a portion of the first amount of the tracked visual display arrangement information.

Example 7 includes the apparatus of example 6, wherein the host-viewer synchronizer circuitry is to transfer the first visual portion of the visual data from the host machine to the viewer machine at a first framerate, and transfer the second visual portion of the visual data from the host machine to the viewer machine at a second framerate, wherein the second framerate is less than the first framerate.

Example 8 includes the apparatus of example 7, wherein the host-viewer synchronizer circuitry is to create a plurality of frames of the visual data on the viewer machine by combining the first visual portion and the second visual portion of the visual data.

Example 9 includes the apparatus of example 6, wherein the host-viewer synchronizer circuitry is to transfer the first visual portion of the visual data from the host machine to the viewer machine at a first pixel resolution, and transfer the second visual portion of the visual data from the host machine to the viewer machine at a second pixel resolution, wherein the second pixel resolution is less than the first pixel resolution.

Example 10 includes the apparatus of any one of examples 1 to 9, further including the processor circuitry to perform at least one of the one or more first operations, the one or more second operations or the one or more third operations to instantiate remote viewer data transfer circuitry to determine whether at least one qualitative attribute of a data link between the host machine and the viewer machine is below an attribute threshold, and send an attribute threshold notification to the host-viewer synchronizer circuitry in response to the at least one qualitative attribute being below the attribute threshold.

Example 11 includes the apparatus of any one of examples 1 to 10, wherein the host-viewer synchronizer circuitry is to transfer at least one synchronizer data packet between the host machine and the viewer machine, the at least one synchronizer data packet including at least a portion of the amount of the visual data.

Example 12 includes at least one non-transitory computer-readable storage medium comprising instructions that, when executed, cause one or more processors to at least determine whether a share mode to share visual data from a host machine to a viewer machine is in an application share mode to share application data associated with an application or in a desktop share mode to share one or more screen captures of an operating system desktop, track a visual display arrangement information of an amount of the visual data on the host machine, display the amount of visual data on the viewer machine as one or more screen captures of the operating system desktop from the host machine by replicating a first amount of the tracked visual display arrangement information on the viewer machine in response to the share mode being in the desktop share mode, and display the amount of visual data on the viewer machine as the application data in an instance of the application by replicating a second amount of the tracked visual display arrangement information on the viewer machine in response to the share mode being in the application share mode.

Example 13 includes the at least one non-transitory computer-readable storage medium of example 12, wherein the instructions, when executed, cause the one or more processors to in response to the share mode being in the application share mode, load the instance of the application on the viewer machine, and transfer a copy of the application data from the host machine to the viewer machine, the application data based on the second amount of the tracked visual display arrangement information.

Example 14 includes the at least one non-transitory computer-readable storage medium of example 13, wherein the instructions, when executed, cause the one or more processors to track an amount of input peripheral usage data for at least one input peripheral associated with the host machine, the amount of input peripheral usage data being at least a portion of the second amount of the tracked visual display arrangement information, and replicate at least a portion of the amount of input peripheral usage data as input peripheral data on the viewer machine.

Example 15 includes the at least one non-transitory computer-readable storage medium of example 14, wherein the instructions, when executed, cause the one or more processors to manipulate the application data in the instance of the application on the viewer machine based on the input peripheral data.

Example 16 includes the at least one non-transitory computer-readable storage medium of any one of examples 12 to 15, wherein the instructions, when executed, cause the one or more processors to, in response to the application being an Internet browsing application viewing a webpage at an address, the address being at least a portion of the second amount of the tracked visual display arrangement information, load the address in the instance of the application on the viewer machine to display the webpage.

Example 17 includes the at least one non-transitory computer-readable storage medium of example 12, wherein the instructions, when executed, cause the one or more processors to in response to the share mode being in the desktop share mode, segment the visual data of a plurality of screen captures into at least two visual portions, wherein a first visual portion of the at least two visual portions is above a threshold modification level of the visual data between the plurality of screen captures, a second visual portion of the at least two visual portions is below a threshold modification level of the visual data between the plurality of screen captures, and the at least two visual portions are at least a portion of the first amount of the tracked visual display arrangement information.

Example 18 includes the non-transitory computer-readable storage medium of example 17, wherein the instructions, when executed, cause the one or more processors to transfer the first visual portion of the visual data from the host machine to the viewer machine at a first framerate, and transfer the second visual portion of the visual data from the host machine to the viewer machine at a second framerate, wherein the second framerate is less than the first framerate.

Example 19 includes the non-transitory computer-readable storage medium of example 18, wherein the instructions, when executed, cause the one or more processors to create a plurality of frames of the visual data on the viewer machine by combining the first visual portion and the second visual portion of the visual data.

Example 20 includes the non-transitory computer-readable storage medium of example 19, wherein the instructions, when executed, cause the one or more processors to transfer the first visual portion of the visual data from the host machine to the viewer machine at a first pixel resolution, and transfer the second visual portion of the visual data from the host machine to the viewer machine at a second pixel resolution, wherein the second pixel resolution is less than the first pixel resolution.

Example 21 includes the non-transitory computer-readable storage medium of any one of examples 12 to 20, wherein the instructions, when executed, cause the one or more processors to determine whether at least one qualitative attribute of a data link between the host machine and the viewer machine is below an attribute threshold, and send an attribute threshold notification to a host-viewer synchronizer circuitry in response to the at least one qualitative attribute being below the attribute threshold.

Example 22 includes the non-transitory computer-readable storage medium of any one of examples 12 to 20, wherein the instructions, when executed, cause the one or more processors to at least transfer at least one synchronizer data packet between the host machine and the viewer machine, the at least one synchronizer data packet including at least a portion of the amount of the visual data.

Example 23 includes a method to perform screen sharing, the method comprising determining whether a share mode to share visual data from a host machine to a viewer machine is in an application share mode to share application data associated with an application or in a desktop share mode to share one or more screen captures of an operating system desktop, tracking a visual display arrangement information of an amount of the visual data on the host machine, displaying the amount of visual data on the viewer machine as one or more screen captures of the operating system desktop from the host machine by replicating a first amount of the tracked visual display arrangement information on the viewer machine in response to the share mode being in the desktop share mode, and displaying the amount of visual data on the viewer machine as the application data in an instance of the application by replicating a second amount of the tracked visual display arrangement information on the viewer machine in response to the share mode being in the application share mode.

Example 24 includes the method of example 23, further including in response to the share mode being in the application share mode, loading the instance of the application on the viewer machine, and transferring a copy of the application data from the host machine to the viewer machine, the application data based on the second amount of the tracked visual display arrangement information.

Example 25 includes the method of example 23, further including in response to the share mode being in the desktop share mode, segmenting the visual data of a plurality of screen captures into at least two visual portions, wherein a first visual portion of the at least two visual portions exceeds a threshold modification level of the visual data between the plurality of screen captures, a second visual portion of the at least two visual portions is below a threshold modification level of the visual data between the plurality of screen captures, and the at least two visual portions are at least a portion of the first amount of the tracked visual display arrangement information.

The following claims are hereby incorporated into this Detailed Description by this reference, with each claim standing on its own as a separate embodiment of the present disclosure.

What is claimed is:

1. An apparatus to implement screen sharing, the apparatus comprising:
processor circuitry including one or more of:
at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
an Application Specific Integrate Circuitry (ASIC) including logic gate circuitry to perform one or more third operations;
the processor circuitry to perform at least one of the one or more first operations, the one or more second operations or the one or more third operations to instantiate:
host-viewer synchronizer circuitry to:
determine whether a share mode to share visual data from a host machine to a viewer machine is in an application share mode to share application data associated with an application or in a desktop share mode to share one or more screen captures of an operating system desktop;
track visual display arrangement information of an amount of the visual data on the host machine;
display the amount of visual data on the viewer machine as one or more screen captures of the operating system desktop from the host machine by replicating a first amount of the tracked visual display arrangement information on the viewer machine in response to the share mode being in the desktop share mode; and
display the amount of visual data on the viewer machine as the application data in an instance of the application by replicating a second amount of the tracked visual display arrangement information on the viewer machine in response to the share mode being in the application share mode.

2. The apparatus of claim 1, wherein the processor circuitry is to perform at least one of the one or more first operations, the one or more second operations or the one or more third operations to instantiate application data uploader circuitry to:
in response to the share mode being in the application share mode,
load the instance of the application on the viewer machine; and
transfer a copy of the application data from the host machine to the viewer machine, the application data based on the second amount of the tracked visual display arrangement information.

3. The apparatus of claim 2, wherein the host-viewer synchronizer circuitry is to:
track an amount of input peripheral usage data for at least one input peripheral associated with the host machine, the amount of input peripheral usage data being at least a portion of the second amount of the tracked visual display arrangement information; and
replicate at least a portion of the amount of input peripheral usage data as input peripheral data on the viewer machine.

4. The apparatus of claim 3, wherein to replicate the second amount of the tracked visual display arrangement information in the instance of the application on the viewer screen, the host-viewer synchronizer circuitry is to:
manipulate the application data in the instance of the application on the viewer machine based on the input peripheral data.

5. The apparatus of claim 1, wherein the host-viewer synchronizer circuitry is to:
in response to the application being an Internet browsing application viewing a webpage at an address,
load the address in the instance of the application on the viewer machine to display the webpage, the address being at least a portion of the second amount of the tracked visual display arrangement information.

6. The apparatus of claim 1, wherein the host-viewer synchronizer circuitry is to:
in response to the share mode being in the desktop share mode,
segment the visual data of the one or more screen captures into at least two visual portions, wherein a first visual portion of the at least two visual portions is above a threshold modification level of the visual data between the plurality of screen captures, a second visual portion of the at least two visual portions is below a threshold modification level of the visual data between the plurality of screen captures, and the at least two visual portions are at least a portion of the first amount of the tracked visual display arrangement information.

7. The apparatus of claim 6, wherein the host-viewer synchronizer circuitry is to:
transfer the first visual portion of the visual data from the host machine to the viewer machine at a first framerate; and
transfer the second visual portion of the visual data from the host machine to the viewer machine at a second framerate, wherein the second framerate is less than the first framerate.

8. The apparatus of claim 7, wherein the host-viewer synchronizer circuitry is to:
create a plurality of frames of the visual data on the viewer machine by combining the first visual portion and the second visual portion of the visual data.

9. The apparatus of claim 6, wherein the host-viewer synchronizer circuitry is to:
transfer the first visual portion of the visual data from the host machine to the viewer machine at a first pixel resolution; and
transfer the second visual portion of the visual data from the host machine to the viewer machine at a second pixel resolution, wherein the second pixel resolution is less than the first pixel resolution.

10. The apparatus of claim 1, further including the processor circuitry to perform at least one of the one or more first operations, the one or more second operations or the one or more third operations to instantiate remote viewer data transfer circuitry to:
determine whether at least one qualitative attribute of a data link between the host machine and the viewer machine is below an attribute threshold; and
send an attribute threshold notification to the host-viewer synchronizer circuitry in response to the at least one qualitative attribute being below the attribute threshold.

11. The apparatus of claim 1, wherein the host-viewer synchronizer circuitry is to:
transfer at least one synchronizer data packet between the host machine and the viewer machine, the at least one synchronizer data packet including at least a portion of the amount of the visual data.

12. At least one non-transitory computer-readable storage medium comprising instructions that, when executed, cause one or more processors to at least:
determine whether a share mode to share visual data from a host machine to a viewer machine is in an application share mode to share application data associated with an application or in a desktop share mode to share one or more screen captures of an operating system desktop;
track a visual display arrangement information of an amount of the visual data on the host machine;
display the amount of visual data on the viewer machine as one or more screen captures of the operating system desktop from the host machine by replicating a first amount of the tracked visual display arrangement information on the viewer machine in response to the share mode being in the desktop share mode; and
display the amount of visual data on the viewer machine as the application data in an instance of the application by replicating a second amount of the tracked visual display arrangement information on the viewer machine in response to the share mode being in the application share mode.

13. The at least one non-transitory computer-readable storage medium of claim 12, wherein the instructions, when executed, cause the one or more processors to:
in response to the share mode being in the application share mode,
load the instance of the application on the viewer machine; and
transfer a copy of the application data from the host machine to the viewer machine, the application data based on the second amount of the tracked visual display arrangement information.

14. The at least one non-transitory computer-readable storage medium of claim 13, wherein the instructions, when executed, cause the one or more processors to:
track an amount of input peripheral usage data for at least one input peripheral associated with the host machine, the amount of input peripheral usage data being at least a portion of the second amount of the tracked visual display arrangement information; and
replicate at least a portion of the amount of input peripheral usage data as input peripheral data on the viewer machine.

15. The at least one non-transitory computer-readable storage medium of claim 14, wherein the instructions, when executed, cause the one or more processors to:
manipulate the application data in the instance of the application on the viewer machine based on the input peripheral data.

16. The at least one non-transitory computer-readable storage medium of claim 12, wherein the instructions, when executed, cause the one or more processors to:
in response to the application being an Internet browsing application viewing a webpage at an address, the address being at least a portion of the second amount of the tracked visual display arrangement information,
load the address in the instance of the application on the viewer machine to display the webpage.

17. The at least one non-transitory computer-readable storage medium of claim 12, wherein the instructions, when executed, cause the one or more processors to:
in response to the share mode being in the desktop share mode,
segment the visual data of a plurality of screen captures into at least two visual portions, wherein a first visual portion of the at least two visual portions is above a threshold modification level of the visual data between the plurality of screen captures, a second visual portion of the at least two visual portions is below a threshold modification level of the visual data between the plurality of screen captures, and the at least two visual portions are at least a portion of the first amount of the tracked visual display arrangement information.

18. The non-transitory computer-readable storage medium of claim 17, wherein the instructions, when executed, cause the one or more processors to:
transfer the first visual portion of the visual data from the host machine to the viewer machine at a first framerate; and
transfer the second visual portion of the visual data from the host machine to the viewer machine at a second framerate, wherein the second framerate is less than the first framerate.

19. The non-transitory computer-readable storage medium of claim 18, wherein the instructions, when executed, cause the one or more processors to:
create a plurality of frames of the visual data on the viewer machine by combining the first visual portion and the second visual portion of the visual data.

20. The non-transitory computer-readable storage medium of claim 19, wherein the instructions, when executed, cause the one or more processors to:
transfer the first visual portion of the visual data from the host machine to the viewer machine at a first pixel resolution; and
transfer the second visual portion of the visual data from the host machine to the viewer machine at a second pixel resolution, wherein the second pixel resolution is less than the first pixel resolution.

21. The non-transitory computer-readable storage medium of claim 12, wherein the instructions, when executed, cause the one or more processors to:
determine whether at least one qualitative attribute of a data link between the host machine and the viewer machine is below an attribute threshold; and
send an attribute threshold notification to a host-viewer synchronizer circuitry in response to the at least one qualitative attribute being below the attribute threshold.

22. The non-transitory computer-readable storage medium of claim 12, wherein the instructions, when executed, cause the one or more processors to at least:
transfer at least one synchronizer data packet between the host machine and the viewer machine, the at least one synchronizer data packet including at least a portion of the amount of the visual data.

23. A method to perform screen sharing, the method comprising:
determining whether a share mode to share visual data from a host machine to a viewer machine is in an application share mode to share application data associated with an application or in a desktop share mode to share one or more screen captures of an operating system desktop;
tracking a visual display arrangement information of an amount of the visual data on the host machine;
displaying the amount of visual data on the viewer machine as one or more screen captures of the operating system desktop from the host machine by replicating a first amount of the tracked visual display arrangement information on the viewer machine in response to the share mode being in the desktop share mode; and
displaying the amount of visual data on the viewer machine as the application data in an instance of the application by replicating a second amount of the tracked visual display arrangement information on the viewer machine in response to the share mode being in the application share mode.

24. The method of claim 23, further including:
in response to the share mode being in the application share mode,
loading the instance of the application on the viewer machine; and
transferring a copy of the application data from the host machine to the viewer machine, the application data based on the second amount of the tracked visual display arrangement information.

25. The method of claim 23, further including:
in response to the share mode being in the desktop share mode,
segmenting the visual data of a plurality of screen captures into at least two visual portions, wherein a first visual portion of the at least two visual portions exceeds a threshold modification level of the visual data between the plurality of screen captures, a second visual portion of the at least two visual portions is below a threshold modification level of the visual data between the plurality of screen captures, and the at least two visual portions are at least a portion of the first amount of the tracked visual display arrangement information.
